(19) United States
(12) Patent Application Publication
(10) Pub. No.: US 2021/0065261 A1
(43) Pub. Date: Mar. 4, 2021

(54) INTERACTIVE MASSAGE SYSTEM

(71) Applicant: Ali Kraayenbrink, Clive, IA (US)

(72) Inventor: Ali Kraayenbrink, Clive, IA (US)

(21) Appl. No.: 17/000,944

(22) Filed: Aug. 24, 2020

Related U.S. Application Data
(60) Provisional application No. 62/892,014, filed on Aug. 27, 2019.

(51) Int. Cl. G06Q 30/02; G06F 3/14

(52) U.S. Cl. CPC G06Q 30/0282; G06Q 30/0281; G06F 3/14

(57) ABSTRACT

An interactive massage system is presented that facilitates a consumer to provide real-time non-verbal feedback to a masseuse during the performance of a massage. In one or more embodiments, the system includes an input device having a housing, a communication module, at least one input, and a feedback monitor device. The input device is provided to the consumer while they are receiving a massage. The consumer uses the input device to provide feedback information to the system during the massage. This feedback information is transmitted by the input device to the feedback monitor device, which communicates visual, auditory, and/or vibrational feedback in real-time to the masseuse while the masseuse is performing the massage.

### CROSS REFERENCE TO RELATED APPLICATIONS

This application also claims priority to U.S. Provisional Application No. 62/892,014 filed Aug. 27, 2019 and titled “INTERACTIVE MASSAGE SYSTEM”, the entirety of which is hereby fully incorporated by reference herein.

### FIELD OF THE DISCLOSURE

This disclosure relates to massages. More specifically and without limitation, this disclosure relates to an interactive massage system where the consumer may provide real-time feedback to the masseuse in a non-intrusive non-verbal manner.

### OVERVIEW OF THE DISCLOSURE

Masseuses have been giving consumers massages for ages. Typically, the consumer lays on a massage table and the masseuse massages their back, neck, shoulders, arms, and/or legs, among other body parts.

The consumer and masseuse often discuss how the consumer wants the massage to be performed and what parts of their body they want the masseuse to focus on before the massage is performed. This information is often vague and indefinite and therefore this conversation does not provide much guidance to the masseuse.

During the performance of the massage, many consumers simply do not like to communicate or provide additional guidance to the masseuse. This may be because the consumer does not feel comfortable speaking up during the massage. This may be because the consumer does not want to interrupt the calming and quiet nature of a massage. This may be because it is difficult for the consumer to talk when they are having their back, neck or shoulders rubbed. This may be because the consumer thinks the masseuse knows what the consumer wants better than the consumer. This may be because the consumer is trying to relax. There may be countless other reasons why the consumer does not communicate or provide additional guidance to the masseuse.

During the performance of the massage, many masseuses do not like to ask the consumer questions. This may be because the masseuse does not feel comfortable asking questions during the massage. This may be because the masseuse does not want to interrupt the calming and quiet nature of a massage. This may be because it is difficult for the consumer to talk when they are having their back, neck or shoulders rubbed. This may be because the masseuse thinks they know what the consumer wants better than the consumer. This may be because they are trying to create a relaxing environment for the consumer. There may be countless other reasons why the consumer does not ask the consumer questions during the massage.

Regardless of the reason for the lack of communication between the consumer and the masseuse during the performance of the massage, there is a lack of guidance or lack of direction or lack of feedback to the masseuse. This lack of guidance, direction or feedback can cause the masseuse to press too hard, or not hard enough. This lack of guidance, direction or feedback can cause the masseuse to spend too much time in some areas and not enough time in some areas. This lack of guidance, direction or feedback can cause the masseuse to prematurely leave a spot when the consumer was really enjoying what the masseuse was doing.

This lack of guidance, direction or feedback can lead to a lower level of satisfaction for the consumer, which ultimately leads to less business for the masseuse.

Presently, there is no solution for these problems.

Thus, it is a primary object of the disclosure to provide an interactive massage system that improves upon the state of the art.

Another object of the disclosure is to provide an interactive massage system that makes it more comfortable for a consumer to provide feedback to the masseuse during a massage.

Yet another object of the disclosure is to provide an interactive massage system that makes it more acceptable for a consumer to provide feedback to the masseuse during a massage.

Another object of the disclosure is to provide an interactive massage system that makes it less awkward for a consumer to provide feedback to the masseuse during a massage.

Yet another object of the disclosure is to provide an interactive massage system that makes it less intrusive for a consumer to provide feedback to the masseuse during a massage.

Another object of the disclosure is to provide an interactive massage system that allows the consumer to provide feedback in real-time to the masseuse during a massage.

Yet another object of the disclosure is to provide an interactive massage system that allows the consumer to provide helpful feedback to the masseuse during a massage.

Another object of the disclosure is to provide an interactive massage system that is comfortable for the consumer to use.

Yet another object of the disclosure is to provide an interactive massage system that the consumer likes to use.

Another object of the disclosure is to provide an interactive massage system that is easy for the masseuse to use.

Yet another object of the disclosure is to provide an interactive massage system that is non-intrusive.

Another object of the disclosure is to provide an interactive massage system that facilitates non-verbal communication.

Yet another object of the disclosure is to provide an interactive massage system that does not harm the relaxing nature of a massage.

Another object of the disclosure is to provide an interactive massage system that improves the consumer's satisfaction with a massage.

Yet another object of the disclosure is to provide an interactive massage system that improves the consumer's satisfaction with a masseuse.

Another object of the disclosure is to provide an interactive massage system that is safe to use.

Yet another object of the disclosure is to provide an interactive massage system that is relatively inexpensive to use.

Another object of the disclosure is to provide an interactive massage system that tracks information about a consumer's massage.

Yet another object of the disclosure is to provide an interactive massage system that facilitates the consumer to have a high level of satisfaction when using a different or new masseuse.

Another object of the disclosure is to provide an interactive massage system that improves efficiencies.

Yet another object of the disclosure is to provide an interactive massage system that is simple for the masseuse to use.

Another object of the disclosure is to provide an interactive massage system that is simple for the consumer to use.

These and other objects, features, or advantages of the present disclosure will become apparent from the specification, claims and drawings.

### SUMMARY OF THE DISCLOSURE

An interactive massage system is presented that facilitates a consumer to provide real-time non-verbal feedback to a masseuse during the performance of a massage. In one or more embodiments, the system includes an input device having a housing, a communication module, at least one input, and a display device. The input device is provided to the consumer while they are receiving a massage. In one arrangement, the at least one input includes a more-pressure, a less pressure and a remain-in-place button. The consumer uses the at least one input on the input device to provide feedback information to the masseuse during the massage. This feedback information is transmitted by the input device to the display device and is displayed in real-time to the masseuse while the masseuse is performing the massage. With this information the masseuse may modify the performance of the massage to suite the consumer's desires thereby improving enjoyment and raising the level of satisfaction of the massage.

### BRIEF DESCRIPTION OF THE DRAWINGS

FIG. 1 shows an interactive massage system, in accordance with one or more embodiments of the present disclosure.

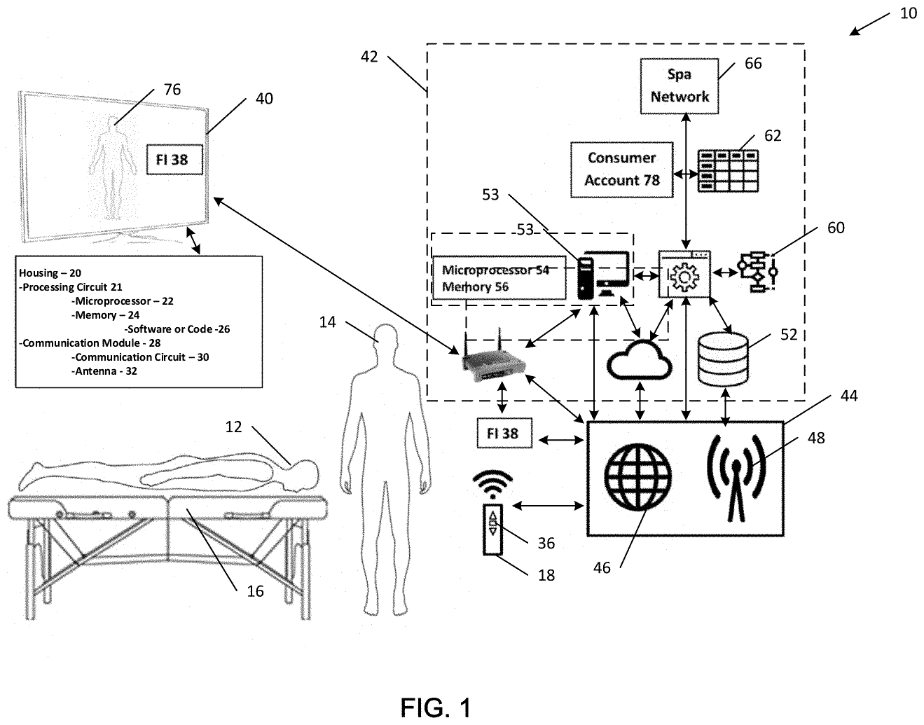

FIG. 2 shows an input device for an interactive massage system, in accordance with one or more embodiments of the present disclosure.

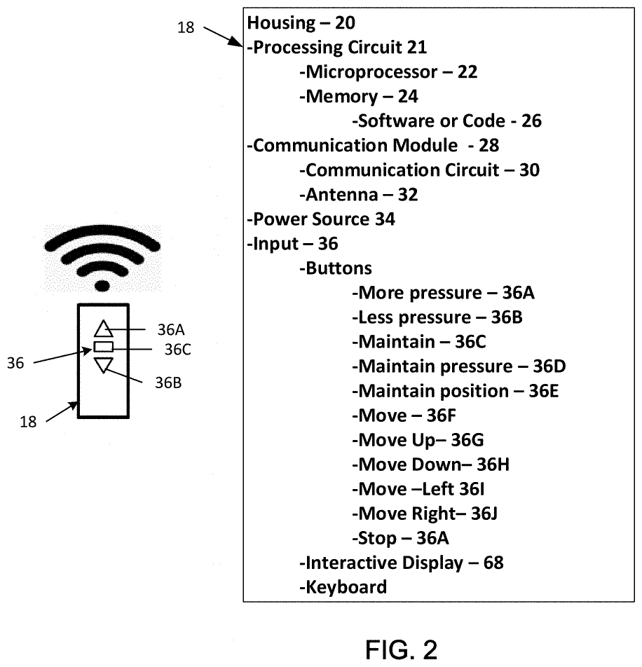

FIG. 3 shows a block diagram of an interactive massage system, in accordance with one or more embodiments of the present disclosure; the view showing input device communicating feedback information to feedback monitor devices through a backend system.

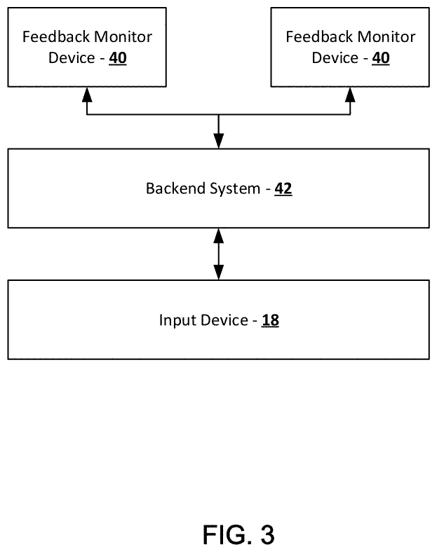

FIG. 4 shows a block diagram of an interactive massage system, in accordance with one or more embodiments of the present disclosure; the view showing input device communicating feedback information directly to feedback monitor devices.

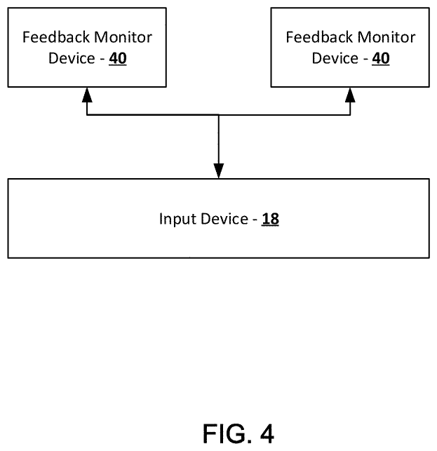

FIG. 5 shows a block diagram of an interactive massage system, in accordance with one or more embodiments of the present disclosure; the view showing input device communicating feedback information directly to one feedback monitor device and communicating feedback information to another feedback monitor device through a backend system.

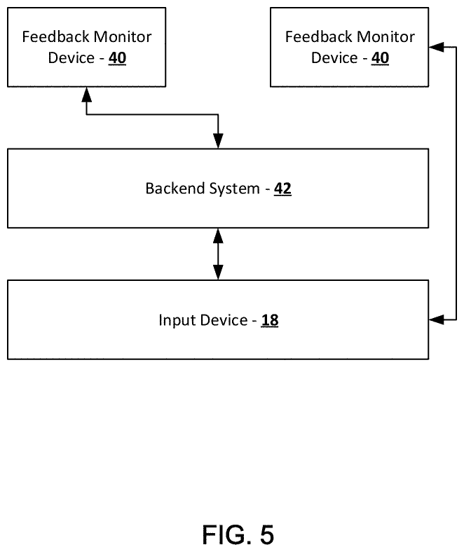

FIG. 6 shows a block diagram of an interactive massage system, in accordance with one or more embodiments of the present disclosure; the view showing a processing circuit, a communication module, inputs, and a power source of the input device.

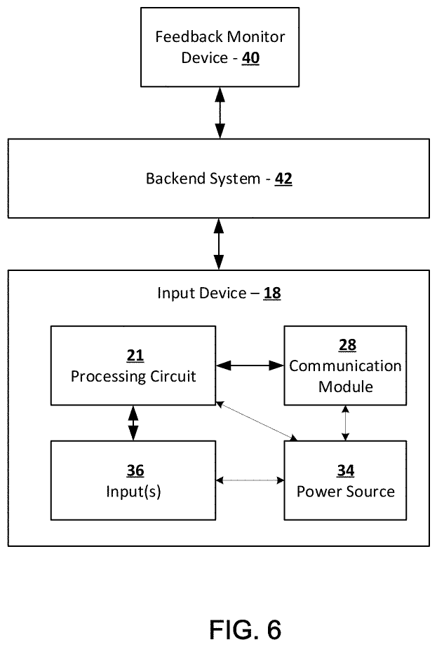

FIG. 7 shows a block diagram of an interactive massage system, in accordance with one or more embodiments of the present disclosure; the view showing a processing circuit, a communication module, inputs, and a power source of the input device; the view showing a microprocessor and a memory of the processing circuit; the view showing a communication circuit and an antenna of the communication module.

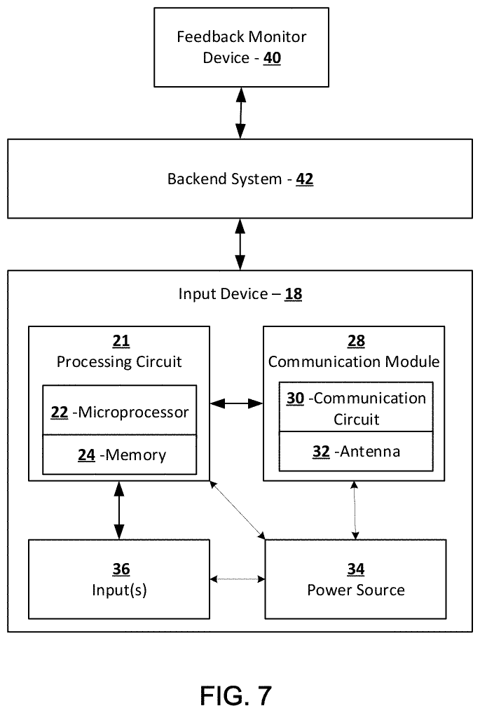

FIG. 8 shows a lower front side perspective view of an input device, in accordance with one or more embodiments of the present disclosure.

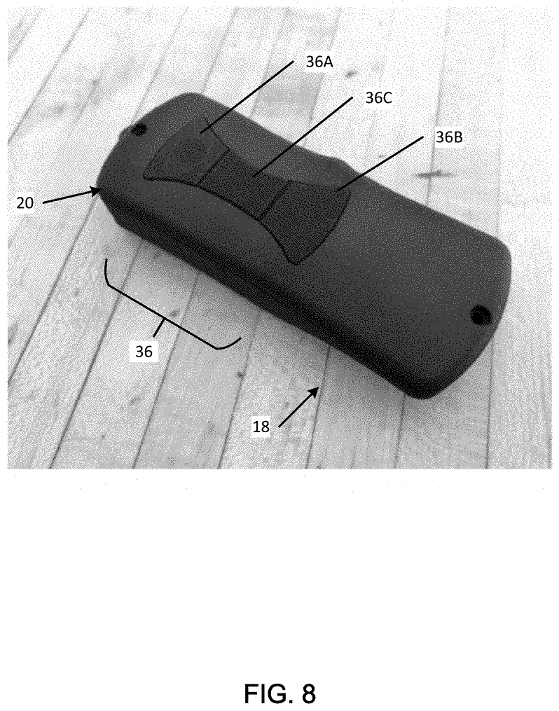

FIG. 9 shows a front view of the input device shown in FIG. 8, in accordance with one or more embodiments of the present disclosure.

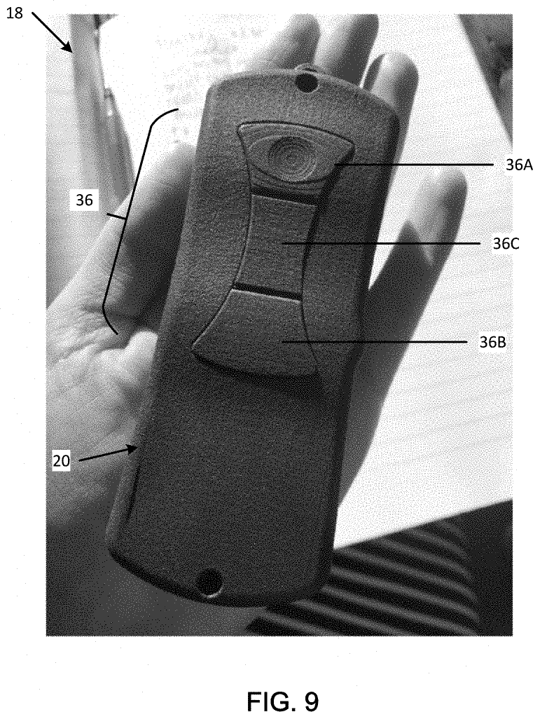

FIG. 10 shows a front left view of the input device shown in FIG. 8, in accordance with one or more embodiments of the present disclosure; the view showing the front cover omitted.

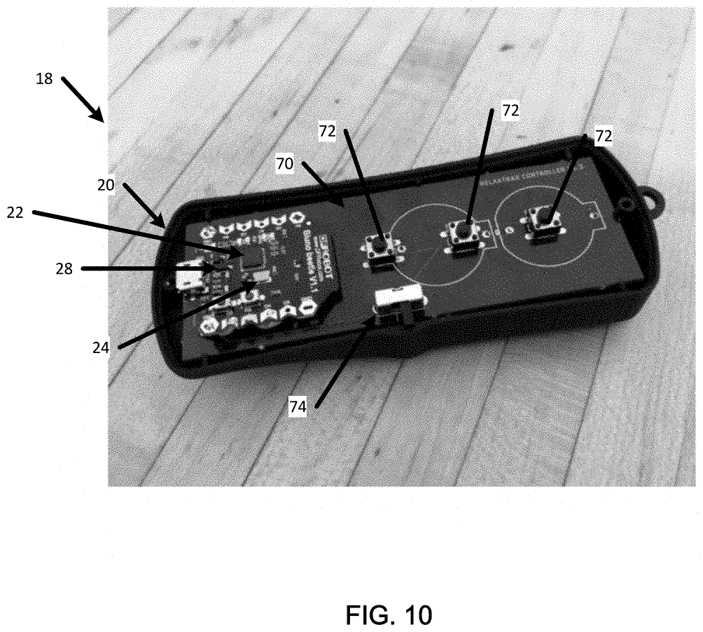

FIG. 11 shows a side view of the input device shown in FIG. 8, in accordance with one or more embodiments of the present disclosure.

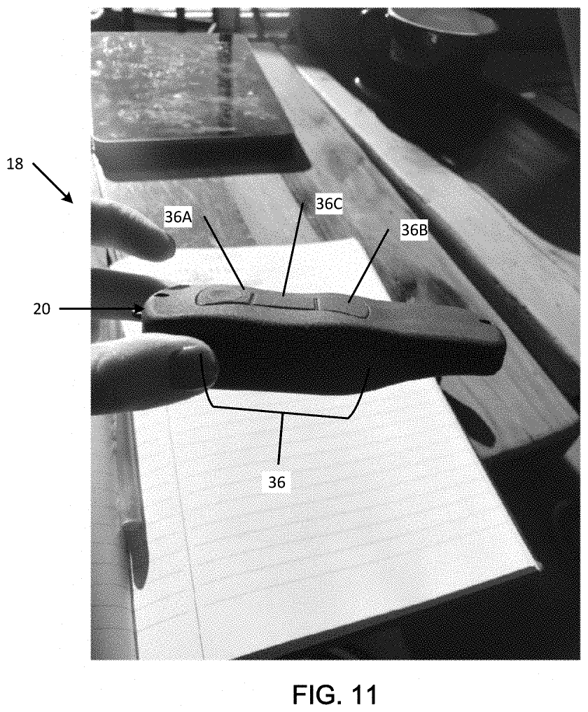

FIG. 12 shows a front side view of the input device shown in FIG. 8, in accordance with one or more embodiments of the present disclosure.

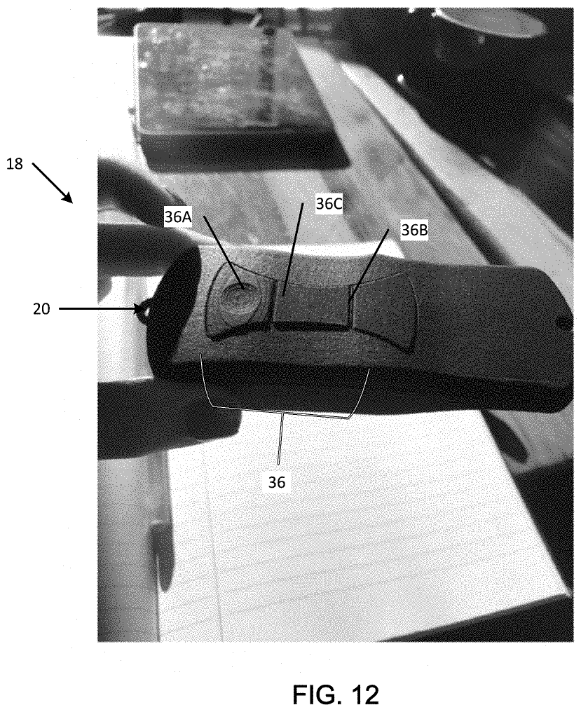

FIG. 13 shows a back side of a printed circuit board of the input device shown in FIG. 8, in accordance with one or more embodiments of the present disclosure.

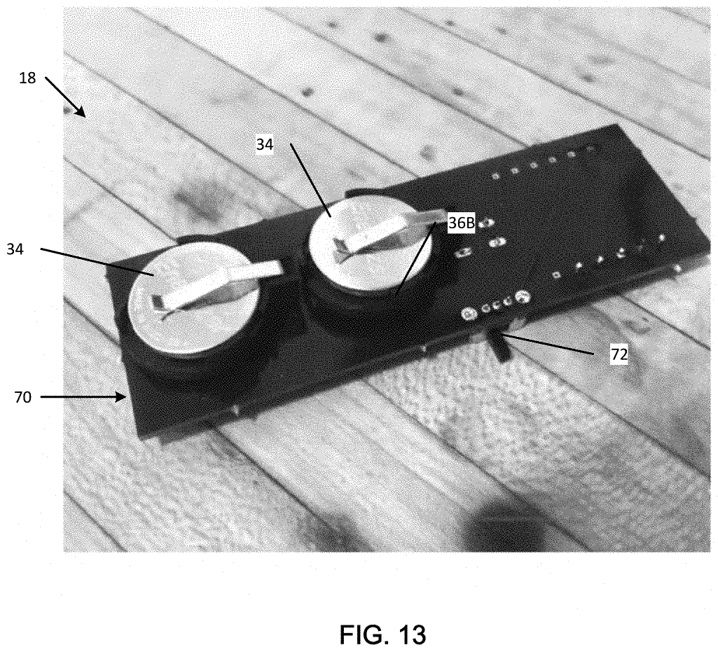

FIG. 14 shows a front side of a printed circuit board of the input device shown in FIG. 8, in accordance with one or more embodiments of the present disclosure.

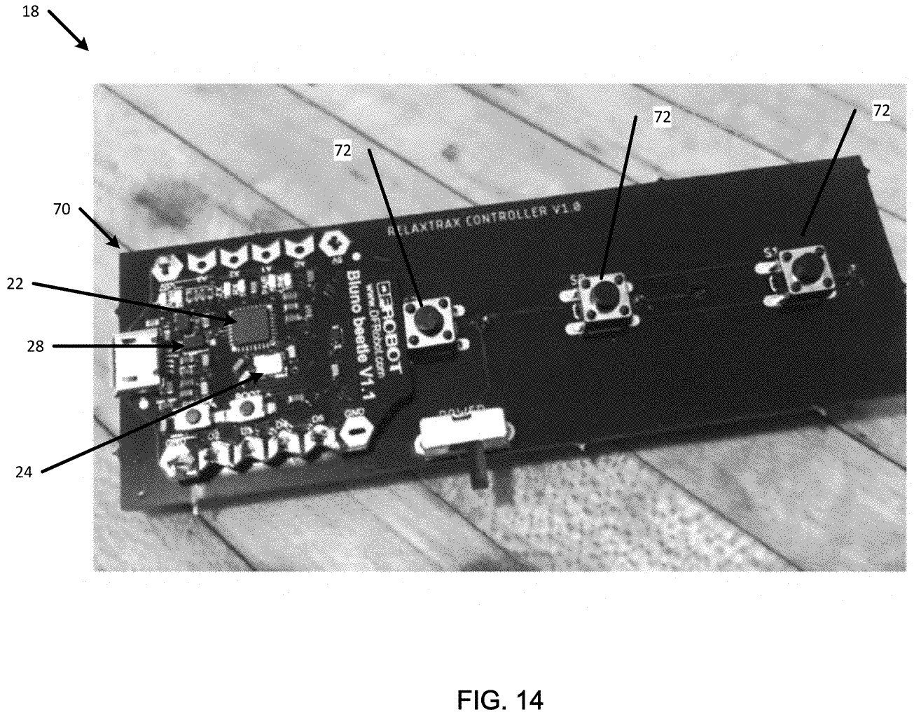

FIG. 15 shows an input device having an interactive display, in accordance with one or more embodiments of the present disclosure.

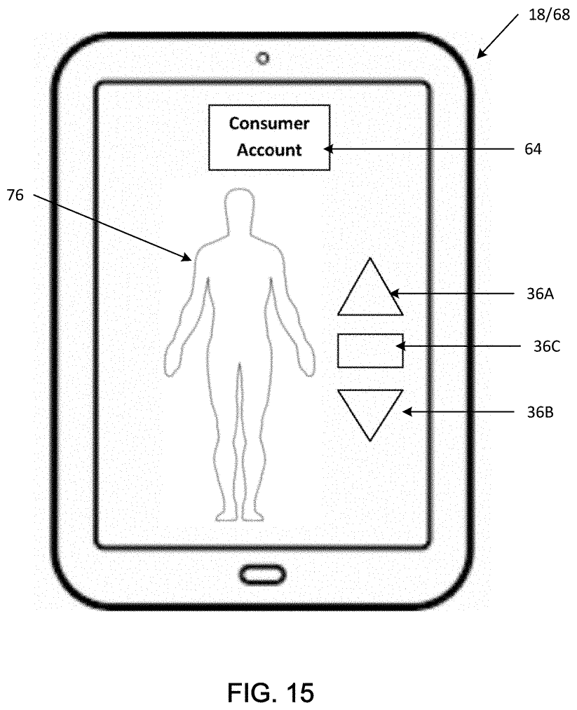

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of massage therapy. However, the embodiments are not so limited. It is appreciated that the embodiments may be adapted for use in other applications which may be improved by the disclosed structures, arrangements and/or methods. The system is merely shown and described as being used in in the context of massage therapy for ease of description and as one of countless examples.

### System:

With reference to the figures, an interactive massage system 10 (or simply system 10) is presented. Interactive massage system 10 is formed of any suitable size, shape and design and is configured to facilitate the improved performance of a massage by providing real-time non-verbal non-invasive information from a consumer 12 to a masseuse 14 during the performance of a massage. In one or more arrangements, interactive massage system 10 may include a massage table 16, an input device 18, a network 44 (e.g., the internet 46 and/or a wireless network 48), the cloud 50, a feedback monitoring device 40 (e.g., a display device), and a backend system 42 including, a database 52, a computing device 53, software code or instructions 58, algorithms 60, data set 62, a consumer account 64 and/or a spa network 66, among other components, pieces, features, processes and systems as is further described herein. In one or more arrangements, the input device 18 has a housing 20, a processing circuit 21, a communication module 28 having a communication circuit 30 (e.g., a receiver, transmitter, or transceiver) and an antenna 32, a power source 34, and at least one input 36 that is used to input feedback information 38.

### Consumer:

In the arrangement shown, as one example, system 10 is configured to receive input from a consumer 12. When system 10 is used in association with massages, consumer 12 is any person that receives a massage from masseuse 14. The system 10 may also be used outside of the world of massage and may be expanded to use during any other form of physical treatment on consumer 12, such as physical therapy, rehabilitation, surgery, chiropractic work, medical attention, dental work, or any form of physical attention or work where it is desirable for the consumer 12 to provide real-time non-verbal non-invasive feedback information 38 to the person or persons performing the physical work or attention. As such, consumer 12 may also be referred to as a patient, receiver, recipient, or any other term that describes a person that receives some form of physical treatment or attention.

### Masseuse:

In the arrangement shown, as one example, system 10 is configured to provide feedback information 38 from consumer 12 to a masseuse 14. When system 10 is used in association with massages, masseuse 14 is any person that performs a massage on consumer 12. The use of the term masseuse is not meant to be limiting to licensed or certified masseuses or massage therapists. The system 10 may also be used outside of the world of massage and may be expanded to use during any other form of physical treatment on consumer 12, such as physical therapy, rehabilitation, surgery, chiropractic work, medical attention, dental work, or any form of physical attention or work where it is desirable for the consumer 12 to provide real-time non-verbal non-invasive feedback information 38 to the person or persons performing the physical work or attention. As such, masseuse 14 may also be referred to as a provider, deliverer, doctor, dentist, or any other term that describes a person that delivers some form of physical treatment or attention.

### Massage Table:

In the arrangement shown, as one example, system 10 is shown in use with a massage table 16. Massage table 16 is formed of any suitable size, shape and design and is configured to support consumer 12 while masseuse 14 performs a massage.

In the arrangement shown, as one example, massage table 16 is a typical four-legged table having a padded upper surface. In the arrangement shown, as one example, consumer 12 lays upon the upper surface of massage table 16 while masseuse 14 performs the massage.

Massage table 16 may be any other form of a support device for consumer 12 such as massage chair or the like. Or, when the system 10 is used outside of the world of massages, massage table 16 may be an operating table, a dentist's chair, or any other support device.

### Input Device:

In the arrangement shown, as one example, system 10 is shown in use with an input device 18. Input device 18 is formed of any suitable size, shape and design and is configured to be provided to the consumer 12 while they receive a massage from masseuse 14 and facilitates the transmission of feedback information 38 to the masseuse 14 in a real-time non-verbal non-invasive manner. In the arrangement shown, as one example, input device 18 includes a housing 20, a processing circuit 21, a communication module 28 having a communication circuit 30 and an antenna 32, a power source 34, at least one input 36 that is used to provide feedback information 38.

Housing: In the arrangement shown, as one example, input device 18 includes a housing 20. Housing 20 is formed of any suitable size, shape and design and is configured provide the exterior shell of input device 18. In the arrangement shown, as one example, housing 20 is a generally elongated member that is longer than it is wide, and it is wider than it is deep and in this way housing 20 fits well within the hand of the consumer 12. In this way, in one arrangement, housing 20 is generally sized and shaped much like a conventional remote control. Housing 20 houses and holds and protects the other components of input device 18.

Processing circuit: In the arrangement shown, as one example, input device 18 includes a processing circuit 21 configured to receive input signals from inputs 36 and/or sensors 72 and provide feedback information 38 to other components of system 10 via communication module 28. In the arrangement shown, as one example implementation, processing circuit 21 includes a microprocessor 22 and memory 24 having software code or instructions 26 that facilitates the computational operation of input device 18. Microprocessor 22 may be any computing device that receives and processes information and outputs commands according to software code or instructions 26 stored in memory 24. Memory 24 may be any form of information storage such as flash memory, ram memory, dram memory, a hard drive, or any other form of memory. Microprocessor 22 and memory 24 may be formed of a single combined unit. Alternatively, microprocessor 22 and memory 24 may he formed of separate but electrically connected components. Alternatively, microprocessor 22 and memory 24 may each be formed of multiple separate but electrically connected components. Software code or instructions 26 is any form of information or rules the provides guidance as to how microprocessor 22 is to receive, interpret and respond to information. Software code or instructions 26 is stored in memory 24 and accessible to microprocessor 22.

As an illustrative example, in one or more arrangements, software code or instructions 26 may configure microprocessor 22 of input device 18 to perform the following steps: 1) discover available networks using communication module 28; 2) establish a communication session with backend system 42 and/or feedback monitor devices 40 over one of the available networks; and 3) during the communication session, generating and communicating feedback information 38 to backend system 42 and/or feedback monitor devices 40 via the one of the available network in response to receiving signals from inputs 36 of input device 18.

Communication Module: In the arrangement shown, as one example, input device 18 includes a communication module 28 having a communication circuit and an antenna 32 that facilitates the transmission of feedback information 38 to other components of the system 10. In various arrangements, the communication circuit may be configured to communicate using various protocols over various networks including but not limited to, for example, 802.11/Wi-Fi, Wi-Max, Bluetooth, UltraWideband (UWB), 802.15.4/ZigBee, ZWave, GSM/EDGE, UMTS/HSPA+/HSDPA, CDMA, LTE, and/or FM/VHF/UHF networks.

In the arrangement shown, as one example, a communication circuit 30 is connected to microprocessor 22. If one way communication is utilized the communication circuit 30 of the input device 18 includes a transmitter to transmit feedback information 38. The transmitter may be any electronic device that facilitates one-way communication, that is, the delivery of information from input device 18 to other components of the system 10. The communication circuit 30 includes a transceiver if two-way communication is utilized by the input device 18. That is, a transceiver is any electronic device that facilitates two-way communication, that is the delivery of information from input device 18 to other components of the system 10 as well as the reception of information from other components of the system 10 to input device 18.

Antenna 32 is any device that is configured to receive wireless signals from over-the-air communication and/or transmit wireless signals in over-the-air communication. In the arrangement shown, as one example, communication circuit 30 is connected with an antenna 32, which may be a monopole antenna, dipole antenna, a loop antenna, a fractal antenna, or any other form of an antenna.

Collectively, communication circuit 30 and antenna 32 are referred to as communication module 28 as communication module 28 facilitates communication between input device 18 and other components of system 10.

Power Source: In the arrangement shown, as one example, input device 18 includes a power source 34. Power source 34 is formed of any suitable size, shape and design and is configured to provide power to input device 18 so as to facilitate the operation of the electrical components of the input device 18. In the arrangement shown, as one example, power source 34 is formed of one or more batteries, which may or may not be rechargeable. Additionally or alternatively, in one or more arrangements, power source 34 may include a solar cell or solar panel that may power or recharge input device 18. Additionally or alternatively, in one or more arrangements, power source 34 may be line-power that is power that is delivered from an external power source into the input device 18 through a wired connection. Any other form of a power source 34 is hereby contemplated for use.

Input: In the arrangement show, as one example, input device 18 includes at least one input 36. Inputs 36 are formed of any suitable size, shape and design and are configured to facilitate real-time non-verbal non-invasive feedback information 38 to be entered by a consumer 12 into input device 18 which is transmitted through the system 10 and displayed on feedback monitor device 40 for viewing by the masseuse 14. In the arrangement shown, as one example, the at least one input 36 is a plurality of buttons that are pressed by consumer 12. In an alternative arrangement, the as one example, at least one input 36 is a touch screen display that facilitates the entry of information by interaction with the interactive display 68. In another alternative arrangement, as one example, the at least one input 36 is a keyboard, mouse and/or GUI (graphical user interface). In an alternative arrangement, as one example, the at least one input 36 is a joystick, a roller ball, a knob, or any other form of an input. Any other form of an input device is hereby contemplated for use.

Three Button Configuration: In the arrangement shown, as one example, input device 18 has a three button configuration. In this arrangement, an upper-positioned button is a more-pressure button 36A, a lower positioned button is a less-pressure button 36B, and a centrally positioned button is a maintain button 36C. This maintain button 36C may be used to indicate, for example, a request for masseuse 14 to maintain position or maintain pressure or both. This may be defined later or during or prior to use.

These buttons 36A, 36B, 36C are held within the housing 20 and are accessible through openings in the upper surface of housing 20. These buttons 36A, 3613, 36C are positioned above a printed circuit board 70 (PCB 70) having sensors 72 positioned below each of the buttons 36A, 36B, 36C. in the arrangement shown, as one example, the PCB 70 connects the electrical components of input device 18 and provides support for the electrical components of input device 18. In the arrangement shown, as one example, these buttons 36A, 3613, 36C are positioned at the upper end of the input device 18 so as to ensure directionality so as to ensure that the remote is not turned around and the more-pressure button 36A is not confused with the less-pressure button 36B

As an example of use, while the consumer 12 is receiving a massage from masseuse 14 and the consumer 12 desires the masseuse 14 to press harder and apply greater pressure, the consumer 12 presses the more pressure button 36A which presses the sensor 72 positioned below the more pressure button 36A. When the sensor 72 is depressed, the sensor 72 transmits a signal to the microprocessor 22. which interprets this signal using software code or instructions 26 stored in memory 24. Microprocessor 22 then transmits feedback information 38 through communication circuit 30 and through antenna 32 of communication module 28. This feedback information 38 is then transmitted using one or more communication protocols and/or communication networks to backend system 42 and eventually is displayed on the display of feedback monitor device 40 where this feedback information 38 is communicated to the masseuse 14 who can then adjust the manner in which they are delivering the massage by increasing the pressure.

Similarly, as another example of use, while the consumer 12 is receiving a massage from masseuse 14 and the consumer 12 desires the masseuse 14 to press lighter and apply less pressure, the consumer 12 presses the less pressure button 36B which presses the sensor 72 positioned below the less pressure button 36B. When the sensor 72 is depressed, the sensor 72 transmits a signal to the microprocessor 22 which interprets this signal using software code or instructions 26 stored in memory 24. Microprocessor 22 then transmits feedback information 38 through communication circuit 30 and through antenna 32 of communication module 28. This feedback information 38 is then transmitted using one or more communication protocols and/or communication networks to backend system 42 and is eventually displayed on the display of feedback monitor device 40, where this feedback information 38 is visible to the masseuse 14, who can then adjust the manner in which they are delivering the massage by decreasing the pressure.

Similarly, as another example of use, while the consumer 12 is receiving a massage from masseuse 14 and the consumer 12 desires the masseuse 14 to maintain the presently delivered pressure or position, the consumer 12 presses the maintain button 36C, which presses the sensor 72 positioned below the maintain button 36C. When the sensor 72 is depressed, the sensor 72 transmits a signal to the microprocessor 22, which interprets, this signal using software code or instructions 26 stored in memory 24. Microprocessor 22 then transmits feedback information 38 through communication circuit 30 and through antenna 32 of communication module 28. This feedback information 38 is then transmitted using one or more communication protocols and/or communication networks to backend system 42 (and/or feedback monitor device 40) and is eventually displayed by feedback monitor device 40 where this feedback information 38 is visible to the masseuse 14 who can then adjust the manner in which they are delivering the massage by maintaining what they are doing which may include maintaining pressure or maintaining position or maintaining both.

In the arrangement shown, as one example, the three button configuration has been tested with success. This may be because the configuration of a more-pressure button 36A positioned at the top side of the row of buttons, a less-pressure button 36B positioned at the lower side of the row of buttons, and a maintain button 36 positioned in the middle of the row of buttons is intuitive to the consumer 12, comfortable for the consumer 12 to use and not overwhelming for the consumer 12 to use. In addition, the use of this three-button configuration may be so intuitive for a consumer 12 they can operate the input device 18 without having to think too much about it, and they can operate it without opening their eyes. In addition, this three-button configuration is so simple that the information provided cannot be confusing to the masseuse 14 and there is little to no possibility that the user can enter the wrong information. As such, the three button configuration presented herein is a simple, concise, easy to use, convenient, comfortable, reasonable, not overly complicated, not overly complex configuration for input. Also, this configuration allows the consumer 12 to provide useful feedback information 38 to the masseuse 14 without taking too much control over the massage or directing the masseuse 14 too much. Or, said another way, the three button configuration allows the consumer 12 to provide feedback information 38 while still allowing the masseuse 14 to direct the massage.

Multi-Button Configuration: In an alternative arrangement, input device 18 may have any number of buttons that serve as inputs 36. This may include any or all or any combination of the following buttons as inputs 36:
More-Pressure 36A—the consumer 12 presses this button when they desire the masseuse 14 to apply more pressure, or to be rougher, or to be more physical.
Less-Pressure 36B—the consumer 12 presses this button when they desire the masseuse 14 to apply less pressure, or to be gentler, or to be less physical.
Maintain 36C—the consumer 12 presses this button when they desire the masseuse 14 to maintain the pressure they are currently using or maintain the position they are currently working, or both. This may be defined before or during the massage. Alternatively, separate buttons can be used to maintain pressure and maintain position.
Maintain-Position 36D—the consumer 12 presses this button when they desire the masseuse 14 to maintain the position they are currently working.
Maintain-Pressure 36E—the consumer 12 presses this button when they desire the masseuse 14 to maintain the pressure they are currently using.
Move 36F—the consumer 12 presses this button when they desire the masseuse 14 to move to a new position.
Move-Up 36G—the consumer 12 presses this button when they desire the masseuse 14 to move upward from the present position.
Move-Down 36H—the consumer 12 presses this button when they desire the masseuse 14 to move downward from the present position.
Move-Left 36I—the consumer 12 presses this button when they desire the masseuse 14 to move left from the present position.
Move-Right 36J—the consumer 12 presses this button when they desire the masseuse 14 to move right from the present position.
Stop 36K—the consumer 12 presses this button when they desire the masseuse 14 to stop or pause or to give the consumer 12 a moment or two before resuming providing the massage.

Any other button or combination of buttons is hereby contemplated for use as inputs 36.

Switch: In one or more embodiments, input device 18 includes a switch 74. Switch 74 is formed of any suitable size, shape and design and is configured to turn input device 18 on and off so as to save battery life. In the arrangement shown, as one example, switch 74 is connected to PCB 70 and extends through housing 20 and slides between an open or off position and a closed or on position. Any other configuration for switch 74 is hereby contemplated for use.

Interactive Display Configuration: In an alternative arrangement, as is shown, as one example, input device 18 includes an interactive display 68. Interactive display 68 may be formed of any suitable size, shape and design and is configured to facilitate the entry of feedback information 38 through interaction with the interactive display 68. This may be through the use of providing a tablet or other device having an interactive display, such as a touchscreen, thereon such as a cell phone or the like.

In the arrangement shown, as one example, inputs 36, or buttons, may be projected/displayed on the screen or display of the interactive display 68. The consumer 12 then interacts with these projected buttons in the same manner as if they were physical buttons as is described herein.

One of the benefits of the use of an interactive display 68 is that other information can be projected on the display of the interactive display 68 that can be used for further feedback information 38. As one example, in the arrangement shown, a human outline 76 is presented on interactive display 68. In this arrangement, the consumer 12 may press, circle or otherwise interact with portions of the human outline 76 to indicate the areas where the consumer wants the masseuse 14 to focus or provide attention to or move to.

In one arrangement, the input device 18 is provided to the consumer 12 prior to the performance of the massage. In this way, the consumer 12 can identify the areas where the consumer 12 wants the masseuse 14 to focus or pay particular attention to.

The consumer 12 can also identify these areas that the consumer 12 wants the masseuse 14 to focus or provide attention to while the masseuse 14 is performing the massage. That is, for example, if the masseuse 14 is focusing on the lower back of the consumer 12 and the consumer 12 wants the masseuse 14 to focus on their shoulders, during the massage the consumer 12 can simply circle the shoulders. This feedback information 38 is then transmitted to feedback monitor device 40 and displayed on the display of the feedback monitor device 40 for the masseuse 14 to see. With this information, masseuse 14 is able to adjust the performance of the massage thereby providing greater satisfaction to the consumer 12.

While the arrangements are primarily described with reference a consumer providing feedback information 38 to input device 8 using hand base manipulation of inputs 36, embodiments are not so limited. Rather, it is contemplated that, in one or more arrangements, input device of other components of system 10 may additionally or alternatively include one or more sensors configured to gather feedback information 38 to aid masseuse 14 without manual hand input by consumer 12. Such sensors may be configured to monitor, for example, eye movement, pupil dilation, heart rate, blood pressure, respiration rate, skin temperature, galvanic skin response (GSR), electroencephalogram (EEG), event-related potentials (ERP), functional near infrared spectroscopy (fNIRS), electrocardiogram (EKG), electromyogram (EMG), and/or facial expressions.

### Display Device:

In the arrangement shown, as one example, system 10 is shown in use with a feedback monitor device 40. Feedback monitor device 40 is formed of any suitable size, shape and design and is configured to provide feedback information 38 provided by consumer 12 through input device 18 to masseuse 14 in a real-time non-verbal non-invasive manner.

Visual Display: In one or more embodiments, feedback monitor device 40 may be formed of any device which displays information. In one or more arrangements, for example, feedback monitor device 40 may include, but is not limited to: a tablet, a TV, a computer screen, a laptop screen, a desktop screen, a phone screen, a smart watch screen, or any other display screen that displays information. In the arrangement shown, as one example, feedback monitor device 40 is flat screen TV display that is hung on the wall of the room where the massage is performed, or placed in any position within the room where the massage is performed that allows the masseuse 14 to easily see the TV display. In an alternative arrangement, more than one feedback monitor device 40 is positioned within the room where the massage is performed so that the masseuse may always see the feedback monitor device 40 regardless of their position.

Worn Display: To avoid directionality and relative movement of masseuse 14, in one arrangement, feedback monitor device 40 is worn by masseuse 14. This may be a smart phone or smart watch or other small feedback monitor device 40 worn on the wrist, arm or any other portion of the body of masseuse 14. By wearing the feedback monitor device 40 the feedback monitor device 40 is always visible and in the same place regardless of where the masseuse 14 is relative to the consumer 12 or room in which the massage is performed.

Vibration: In one arrangement, when the feedback monitor device 40 is worn by the masseuse 14, the feedback monitor device 40 may communicate in non-verbal, non-audible, non-visual ways, such as through vibrating. That is, in this arrangement, as one example, the feedback monitor device 40 may vibrate once for less pressure, twice for maintain in place, and three times for more pressure, as one of countless examples. This vibration may be coupled with a visual display as well, or it may be independent of a visual display. This arrangement is not unlike a smart watch vibrating when a new call or message comes in.

Lights: In an alternative arrangement, feedback monitor device 40 may be one or more lights that light up in various ways or various colors depending upon the feedback information 38 provided.

Sounds: In an alternative arrangement, feedback monitor device 40 may be an audible device that provides various sounds depending upon the feedback information provided. In one arrangement, when display device is an audible device, as one example, the feedback monitor device 40 may make an audible noise, such as a beep or tone, once for less pressure, twice for maintain in place, and three times for more pressure, as one of countless examples. Alternatively, in one arrangement, when feedback monitor device 40 is an audible device, as one example, the feedback monitor device 40 may make a different audible noise, such as a beep or tone, for less pressure, for maintain in place, and for more pressure, as one of countless examples. In one arrangement, when feedback monitor device 40 is an audible device, an earpiece is used so that the audible noise is only heard by the masseuse 14 and therefore it does not interrupt the consumer 12.

Any combination of these manners of displaying information through feedback monitor device 40 are hereby contemplated for use. As such, as one example, a masseuse 14 may use multiple screens in the room that the massage is performed, as well as using a screen worn on their arm as well as receiving vibrational messages as well as using an earpiece that delivers audible messages.

In one arrangement, when input device 18 includes an interactive display 68, the feedback monitor device 40 displays the same visual as the input device 18. That is, as one example, when the interactive display of input device 18 includes a human outline 76 and a more-pressure button 36A, a less-pressure button 36B and a maintain button 36C, this is similarly displayed on the feedback monitor device 40 along with real-time feedback information 38. As one example, when a consumer 12 presses the more pressure button 36A on the input device 18 in real time the up arrow of the more pressure button 36A on feedback monitor device 40 illuminates or changes color or increases in size, or flashes or any combination of these effects for a predetermined amount of time after the consumer 12 presses the more-pressure button 36A. As one example, when a consumer 12 interacts with the interactive display 68 of the input device 18 and circles the left shoulder on the human outline 76 in real time the same area on the human outline 76 on feedback monitor device 40 illuminates or changes color or increases in size, or flashes or any combination of these effects for a predetermined amount of time after the consumer 12 interacts with the interactive display 68 of the input device 18. In this way, the consumer 12 can provide valuable feedback information 38 to the masseuse 14 thereby improving the satisfaction level with the massage.

### Indirect Communication:

In one arrangement, as one example, feedback information 38 from input device 18 is communicated to feedback monitor devices 40 through backend system 42. Backend system 42 is formed of any suitable size, shape and design and is configured to receive feedback information 38 from input device 18 via one or more communication protocols and/or communication networks and provide the feedback information 38 in an appropriate format to one or more feedback monitor devices 40 for communication of the feedback information 38 to masseuse 14. In one or more arrangements, backend system 42 may be a router, a wireless router, a network switch, a modem, a wireless modem, a dongle, or any other device that receives wireless information from input device 18 and transmits it to feedback monitor device 40. Additionally or alternatively, backend system may include one or more computing devices 53 configure to receive feedback information 38 from input device 18 (via one or more communication protocols and/or communication networks) and communicate the feedback information 38 in an appropriate format to one or more feedback monitor devices 40 (via one or more communication protocols and/or communication networks) for communication of the feedback information 38 to masseuse 14.

### Direct Communication:

In one arrangement, as one example, input device 18 communicates directly with feedback monitor device 40 through over-the-air communication. In one arrangement, this is accomplished by feedback monitor device 40 having a microprocessor 22, memory 24, software code or instructions 26, a communication module 28 having a communication circuit 30, and antenna 32 that are similar to if not identical to that described herein with respect to input device 18. In a manner of speaking, in this arrangement, feedback monitor device 40 is what is known as a smart TV, a smart watch, a smart phone or any other device which has the hardware and computational capabilities to receive feedback information 38 directly from input device 18 and display this information on the display of feedback monitor device 40. In one arrangement, feedback monitor device 40 is installed with an app or software application that facilitates the seamless reception of feedback information 38 from input device and the display of feedback information 38 on the display of feedback monitor device 40. In one or more embodiments, input device 18 may additionally communicate the feedback information 38 to backend system 42 for communication of the feedback information to one or more additional devices, for data storage, and/or for data processing.

### Consumer's Handheld Device:

In one arrangement, the consumer 12 may use the consumer's own handheld device or smart phone with an app downloaded onto the smart phone as the input device 18. This is convenient as all consumers 12 have a smart phone that has an interactive display 68. Upon the download and installation of the application of system 10, the interactive display 68 of the consumer's smart phone displays the human outline 76 and/or inputs 36 as the consumer's handheld device becomes the input device 18 during the massage.

This arrangement is convenient as it allows the quick and seamless transfer of information about the consumer 12 to the system 10. As such, the consumer 12 can establish a consumer account 64 that includes all of the personal information of the consumer 12 such as name, sex, age, height, weight, massage history, personal massage preferences, health information, or any other personal information. By establishing a consumer account 64 the user can simply open the application login prior to the massage being performed and all of this information may be transmitted to the masseuse 14 for use during the massage.

In one arrangement, each time the consumer 12 uses the system 10, the information provided by the consumer 12 is stored in their account, such as the number and dates of massages, focus areas, and the like, as well as information provided during the massage from either the consumer 12 or the masseuse 14. As an example, if during the massage the consumer indicated more-pressure twenty-times during the massage, this would be recorded in the consumer's account 64. This recording of information to the consumer's account 64 allows an unprecedented amount of information to be transmitted to the masseuse 14 prior to the massage being performed. In addition, this information is accessible to the masseuse 14 during the performance of the massage by display on the feedback monitor device 40, which allows the masseuse 14 to be constantly reminded of the preferences of the consumer 12, which may be said or unsaid, during the performance of the massage. The recordation and transfer of this information allows the consumer 12 to get the highest level of satisfaction out of differing masseuses 14 by providing them with the information stored in the consumer account 64.

### Network, Cloud, Database:

In the arrangement shown, as one example, feedback information 38 may be transmitted from input device 18 through a network 44 to the cloud 50 and/or a database 52 where the feedback information 38 is stored along with the consumer account 64. In one arrangement, network 44 may include the internet 46 and/or a wireless network 48 such as a local wireless Wi-Fi network, or a cellular network, such as wireless communication through cell towers.

In one or more embodiments, feedback information 38 and consumer account 64 information of the consumer 12 may be processed along with all the other consumer account 64 information of other consumers 12 using a computing device 53 to perform data analytics. The computing device 53 may have, for example, at least one microprocessor 54 and memory 56 with software code or instructions 58 (which are similar to those described herein with respect to input device 18 and therefore reference is made to those portions of the disclosure to save redundancies) as well as algorithms 60.

This processing allows the system 10 to analyze, distill and process the macro-data all the way down to the micro-consumer-specific data, received from all consumers 12 using the system 10. From this macro-data all the way down to the micro-consumer-specific data the system 10, using computing device 53 having at least one microprocessor 54 and memory 56 with software code or instructions 58 as well as algorithms 60 can uncover insights, provide consumer specific suggestions, target macro-advertising as well as micro-advertising to consumers 12 advertise.

Additionally or alternatively, in one or more embodiments, the computing device 53 may perform data analytics on feedback information 38 and consumer account 64 information of the consumer 12 to determine and store consumer massage preferences based on the previous feedback. In one or more arrangements, the computing device 53 may be configured to retrieve and display determined user preferences to a masseuse on a consumers next visit.

Additionally or alternatively, the computing device 53 may perform data analytics on the macro-data evaluate and assess different masseuses 14 and/or recommend particular masseuses 14 to a particular consumer 12 based on previous feedback information 38 provided by the consumer 12.

In one or more embodiments, a computing device 53 may be configured and arranged to monitor, learn, and modify data analytics processes and/or filters and/or control of one or more features, functions, and/or operations of the system. For instance, a control circuit may be configured to monitor and locally or remotely store data relating to feedback information 38 and operation of the system. The control circuit may be configured to analyze the data and predict, over time, consumer behavior and/or likely purchases for marketing purposes. Such learning may include, for example, generation and refinement of classifiers and/or state machines configured to map input data values to desired operations to be performed by the control circuit. In various embodiments, analysis by the control circuit may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof. The system 10 may combine the data from all consumers and all consumer accounts 64 into a data set 62, or data table. This data set 62 may be made available to a spa network 66 that buys into the system 10. In this way, spas in the spa network 66 have access to both the macro-data trends and information from all consumers 12 that use the system 10 as well as the specific information in each consumer account 64. As such, this should cause consumers 12 to provide preference to spas in the spa network 66 as they use the system 10 and have direct access to the consumer account 64.

### In Operation:

In the arrangement shown, as one example, the system 10 operates in the following manner. A consumer 12 is provided with input device 18 prior to the consumer 12 receiving a massage from a masseuse 14. In one arrangement, when the input device 18 includes an interactive display 68 with a human outline 76 thereon, the consumer 12 may indicate on the human outline 76 the areas of their body that the consumer 12 would like the masseuse 14 to provide particular attention to. The consumer 12 may also enter their personal information thereby pulling up their consumer account 64 and associating the information of the present massage with their consumer account 64.

During the performance of the massage, the information from the consumer account 64 is provided to the masseuse 14 in one way through the display on the feedback monitor device 40. During the performance of the massage, the consumer 12 may interact with an input 36 of the input device 18 to provide feedback information 38 to the masseuse 14. In one arrangement this is accomplished by the consumer 12 pressing a button on input device 18.

When the user presses an input 36 of input device 18, which in this example is a button, the button is depressed. This depresses a sensor 72 on the PCB 70 beneath the button. Upon this depression of sensor 72 beneath the button a signal is transmitted to the microprocessor 22 which interprets this signal using software code or instructions 26 stored in memory 24. In response to receiving this signal, microprocessor 22 transmits an appropriate signal through over the air communication using communication module 28 having communication circuit 30 and antenna 32. This wireless signal is received either directly by feedback monitor device 40, which displays the information on the display (or transmits a vibration, a noise or tone, or any combination thereof or otherwise as may be the case in the particular configuration of the system). Alternatively, this wireless signal is received either by backend system 42 which then transmits the signal to feedback monitor device 40, which displays the information on the display (or transmits a vibration, a noise or tone, or any combination thereof or otherwise as may be the case in the particular configuration of the system). This feedback information 38 is delivered in real-time, which means instantaneously, almost instantaneously, or nearly instantaneously, to the feedback monitor device 40 which is then received by the masseuse 14 who then can immediately modify the performance of the massage to the greater satisfaction of the consumer. This process continues throughout the performance of the massage.

At any time during or after the massage, feedback information 38 is transmitted over network 44 to the cloud 50 and/or stored in database 52 of system 10 in association with the consumer account 64 of consumer 12. This information is accessible to all spas that are part of the spa network 66.

Various blocks, modules, or other circuits may be implemented to carry out one or more of the operations and activities described herein and/or shown in the figures. In these contexts, a “block” (also sometimes “logic circuit”, “control circuit,” “controller,” “module”, “device” or simply “circuit”) is an electrical circuit specifically configured and arranged to carry out one or more of these or related operations/activities. For example, control circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions which may be executed by a computer (or other electronic device) to perform these operations/activities. From the above discussion it will be appreciated that the interactive massage system 10 and related methods of use, presented herein improves upon the state of the art.

Specifically, the interactive massage system 10 and related methods of use presented: makes it more comfortable for a consumer to provide feedback to the masseuse during a massage; makes it more acceptable for a consumer to provide feedback to the masseuse during a massage; makes it less awkward for a consumer to provide feedback to the masseuse during a massage; makes it less intrusive for a consumer to provide feedback to the masseuse during a massage; allows the consumer to provide feedback in real-time to the masseuse during a massage; allows the consumer to provide helpful feedback to the masseuse during a massage; is comfortable for the consumer to use; consumer likes to use; is easy for the masseuse to use; is non-intrusive; facilitates non-verbal communication; does not harm the relaxing nature of a massage; improves the consumer's satisfaction with a massage; improves the consumer's satisfaction with a masseuse; is safe to use; is relatively inexpensive to use; tracks information about a consumer's massage; facilitates the consumer to have a high level of satisfaction when using a different or new masseuse; improves efficiencies; is simple for the masseuse to use; is simple for the consumer to use, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A system for providing feedback information during a massage, comprising:
an input device;
the input device having a housing;
the input device having a communication module;
the input device having at least one input;
a display device;
wherein the input device is provided to a consumer while the consumer is receiving a massage from a masseuse;
wherein the consumer uses the at least one input of the input device to provide feedback information regarding the massage to the masseuse while the consumer is receiving the massage from the masseuse;
wherein the feedback information provided by the consumer regarding the massage is displayed on the display device while the consumer is receiving the massage from the masseuse;
wherein the masseuse receives the feedback information provided by the consumer regarding the massage by viewing the display device while the consumer is receiving the massage from the masseuse.

2. The system of claim 1, further comprising wherein the at least one input is a plurality of buttons.

3. The system of claim 1, wherein at least one of the at least one input is selected from the group consisting of: a more-pressure input; a less-pressure input; a maintain-pressure input; a remain in-place input; a move input; a move up input; a move down input; a move left input; and a move right input.

4. The system of claim 1, further comprising wherein the feedback information is delivered to the masseuse in real time while the consumer is receiving the massage.

5. The system of claim 1, further comprising wherein the input device is a wireless remote control.

6. The system of claim 1, wherein the display device is selected from the group consisting of: a tablet; a TV, a computer screen, a laptop computer, a phone, and a smart watch.

7. A system for providing feedback information during a massage, comprising:
an input device;
the input device having at least one input;
a display device;
wherein the input device is given to a consumer while the consumer receives a massage from a masseuse;
wherein when the consumer receives the massage from the masseuse, the consumer provides feedback information using the at least one input on the input device which is transmitted to the display device and displayed on the display device for the masseuse to see in real time while the masseuse is providing the massage.

8. The system of claim 6, further comprising wherein the masseuse receives the feedback information provided by the consumer regarding the massage by viewing the display device while the consumer is receiving the massage from the masseuse.

9. The system of claim 6, further comprising wherein the at least one input is a plurality of buttons.

10. The system of claim 6, wherein at least one of the at least one input is selected from the group consisting of: a more-pressure input; a less-pressure input; a maintain-pressure input; a remain in-place input; a move input; a move up input; a move down input; a move left input; a move right input.

11. The system of claim 6, wherein the display device is selected from the group consisting of: a tablet; a TV, a computer screen, a laptop computer, a phone, and a smart watch.

12. A system for a consumer to provide feedback information to a masseuse during a massage, comprising:
an input device;
the input device having a housing;
the input device having a communication module;
the input device having at least one input;
a display device;
a backend system;
wherein the backend system is communicatively connected to the input device and the display device;
wherein the input device is provided to the consumer during the massage;
wherein the input device is configured and arranged to receive feedback information from the consumer during the massage;
wherein the input device is configured and arranged to communicate the feedback information to the backend system; and
wherein the backend system is configured and arranged to prompt the display device to display feedback indicated by the feedback information to the masseuse, thereby providing real-time feedback regarding the massage to the masseuse.

13. The system of claim 12, wherein the at least one input is a plurality of buttons;
wherein the backend system is configured and arranged to:
in response to receiving feedback information indicating a first one of the plurality of buttons was pressed, prompt the display device to display a message indicating more pressure is requested;
in response to receiving feedback information indicating a second one of the plurality of buttons was pressed, prompt the display device to display a message indicating less pressure is requested; and
in response to receiving feedback information indicating a third one of the plurality of buttons was pressed, prompt the display device to display a message indicating maintain pressure is requested.

14. The system of claim 12, wherein the at least one input is a plurality of buttons;
wherein the backend system is configured and arranged to:
in response to receiving feedback information indicating a first one of the plurality of buttons was pressed, prompt the display device to display a message indicating move of location is requested; and
in response to receiving feedback information indicating a second one of the plurality of buttons was pressed, prompt the display device to display a message indicating remain in-place is requested.

15. The system of claim 12, wherein the at least one input is a plurality of buttons;
wherein the backend system is configured and arranged to:
in response to receiving feedback information indicating a first one of the plurality of buttons was pressed, prompt the display device to display a message indicating movement upward is requested;
in response to receiving feedback information indicating a second one of the plurality of buttons was pressed, prompt the display device to display a message indicating movement downward is requested;
in response to receiving feedback information indicating a third one of the plurality of buttons was pressed, prompt the display device to display a message indicating movement leftward is requested;
in response to receiving feedback information indicating a fourth one of the plurality of buttons was pressed, prompt the display device to display a message indicating movement rightward is requested.

16. The system of claim 12, further comprising a feedback monitor device communicatively connected to the backend system;
wherein the backend system is configured and arranged to prompt the feedback monitor device to provide auditory feedback, corresponding to the feedback information, to the masseuse.

17. The system of claim 12, further comprising a feedback monitor device communicatively connected to the backend system;
wherein the backend system is configured and arranged to prompt the feedback monitor device to provide vibrational auditory feedback, corresponding to the feedback information, to the masseuse.

18. The system of claim 12, further comprising a feedback monitor device communicatively connected to receive feedback information directly from the input device; and
wherein the feedback monitor device is configured and arranged to provide visual, auditory, or vibrational feedback, corresponding to the feedback information, to the masseuse.

19. The system of claim 12, wherein the backend system is configured to record and store feedback information received from the input device.

20. The system of claim 12, wherein the backend system is configured to store feedback information received from the input device for a consumer;
wherein the backend system is configured to perform data analytics on the stored feedback information to determine preferences of the consumer; and
wherein the backend system is configured and arrange to display, during a subsequent massage session with the consumer, display the determined preferences on the display device to the masseuse.
